(19) United States
(12) Patent Application Publication
(10) Pub. No.: US 2008/0057937 A1
(43) Pub. Date: Mar. 6, 2008

(54) Method and Apparatus to Troubleshoot Voice Over Internet Protocol (VolP)

(76) Inventor: Marek Kotelba, Rockville, MD (US)

Correspondence Address: TEXAS INSTRUMENTS INCORPORATED, P O BOX 655474, M/S 3999, DALLAS, TX, 75265, US

(21) Appl. No.: 11/828,393

(22) Filed: Jul. 26, 2007

Related U.S. Application Data
(60) Provisional application No. 60/823,795, filed on Aug. 29, 2006.

(51) Int. Cl. H04Q 7/20

(52) U.S. Cl. 455/423

(57) ABSTRACT

Embodiments of the invention provide method and apparatus to allow a subscriber to enter a pre-specified digit sequence using the phone terminal's keypad to induce a special data collection mode for the impaired call. The digit sequence is handled in a special manner to avoid inadvertent selection of options in an Interactive Voice Response (IVR) system into which the subscriber may be dialed, or inadvertent triggering of network-based supplementary call services.

### CROSS-REFERENCE TO RELATED APPLICATIONS

This application claims priority to U.S. Provisional Application No. 60/823,795, filed Aug. 29, 2006, entitled “Method and Apparatus to Troubleshoot Voice-Over-IP (VoIP)”, Marek Kotelba, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Embodiments of the invention are directed, in general, to Voice over Internet Protocol IP (VoIP) systems and, more specifically, to troubleshooting VoIP by using special data collection mode.

With the recent development and widespread availability of broadband Internet connections, many new voice, video, and data services are being offered that take advantage of the additional bandwidth. One such voice service is the voice over Internet Protocol (VoIP), which enables the routing of voice conversations over Internet Protocol (IP) networks such as the Internet. Bypassing the traditional packet switched telephone network (PSTN), consumers may make free VoIP-to-VoIP calls anywhere in the world with an Internet connection and consumers may gain significant cost savings with PSTN-to-VoIP or VoIP-to-PSTN calls.

In typical telecommunications systems, voice calls and data are transmitted by carriers from one network to another network. Networks for transmitting voice calls include packet-switched networks transmitting calls using Voice over Internet Protocols (VoIP), circuit-switched networks like the public switched telephone network (PSTN), asynchronous transfer mode (ATM) networks, etc. Recently, voice over packet (VOP) networks are becoming more widely deployed. Many incumbent local exchange and long-distance service providers use VoIP technology in the backhaul of their networks without the end user being aware that VoIP is involved.

Traditional service providers use techniques to manage service quality developed over the last 100 or more years for circuit-switched networks. Methods include tracking of customer and network trouble reports and re-design of voice networks. Service providers use well-understood rules to characterize service level in terms of voice quality (e.g., based on loss, delay, and echo), and in difficultly in establishing a call. Then, a service provider's main tool to assess service quality while the network is in operation is based on trouble reports from users, as well as general network equipment failure notification.

Voice quality is traditionally thought of as the end user's perception of quality. Network performance will affect voice quality. However, as VoIP technology increases in demand on a network and networks become more complicated with connections through the Internet and PSTN using IP phones (wired and wireless) and residential voice gateways, VoIP providers have a much more difficult time assuring the voice quality for their subscribers. Reasons for this include lack of control over the underlying transport network, such as when a service provider providing voice service from a residential gateway attaches to another provider's residential broadband cable modem or DSL (Digital Subscriber Line) service and the use of transport technology that can vary in quality. For example, using wireless local area network (WLAN) media to transport VoIP, especially when the wireless end user is moving between WLANs.

An example of networks and components for a VoIP call is illustrated in FIG. 1. Access network 10 could be any network accessing the Internet such as an IP, Asychronous Transfer Mode (ATM), or Ethernet network, which is a managed broadband network. Network 10 comprises a router 14 connected to various customer premise equipment and to media gateway 12. Media gateway 12 must be capable of detecting changing resource or network conditions. The ability to detect and monitor changing resource and network conditions can result in significant cost reductions and/or improved quality. Router 14 is connected to Internet Access Device (IAD) 16, wireless access point (AP) 22, and/or IP PBX (personal branch exchange) 32. A voice call may be placed between any of the customer equipment phones 18 connected to IAD 16, wireless IP phone 24 connected to AP 22, or IP PBX phone 30. Using special software, calls could also be placed through computer 20 connected to IAD 16 or portable computer 26 connected to AP 22.

Customer equipment is connected through access broadband network 10 to the Internet 34 by gateway 12. On the far end is the PSTN 48, networking to the plain old telephone service (POTS) phone 52 through a Central Office 50. PSTN is also connected to the Internet 34 through a trunk gateway, composed of signal gateway 44, media gateway controller/proxy (MGC) 42, and trunk media gateway (MG) 46. IP and packet data (e.g., real time protocol (RTP packet data)) associated with the call is routed between IAD 16 and trunk MG 46. The trunk gateway system provides real-time two-way communications interfaces between the IP network (e.g., the Internet) and the PSTN 50. As another example, a VoIP call could be initiated between WIPP 24 and WIPP 40 connected to AP 38. In this call, voice signals and associated packet data are sent between Gateway 12 and AP 38 through Internet 34, thereby bypassing the PSTN 48 altogether.

Factors that affect voice quality in a VoIP network are fairly well understood. The level of control over these factors will vary from network to network. This is highlighted by the differences between a well-managed private enterprise network versus an unmanaged network such as the Internet. Network operational issues affect network performance and will create conditions that affect voice quality. These issues include outages/failures of network switches, routers, and bridges; outages/failure of VoIP elements such as call servers and gateways; and traffic management during peak periods and virus/denial of service attacks.

Software for VoIP systems is a critical ingredient of high-quality VoIP systems. There are many features that must be implemented for carrier-class systems. The most important software features include echo cancellation, voice compression, packet play-out software, tone processing, fax and modem support, packetization, signaling support, and network management. New networking technologies and deployment models are also causing additional challenges that affect the ability of VoIP service providers to guarantee the highest levels of service quality (e.g., toll quality) in their deployments. Two such examples are where the VoIP service provider does not control the underlying packet transport network, and the use of packet networks with potentially high delay and loss, such as in 802.11 WLAN technology.

The ability to detect and report on events in a network that adversely affect voice quality is critical for managing a voice network. The oldest network voice quality tool is the listening opinion tests, where human listeners rate call quality in a controlled setting (from ITU-T Spec. P.800). Overall results are compiled to produce a mean opinion score (MOS), which is based on a panel of listeners ranking the quality of a series of call samples on a scale of 1 (Bad) to 5 (Excellent). An aggregate score of 4 or more is considered toll quality, which is the standard for the PSTN. While this test has the disadvantage of being subjective, expensive, and time-consuming to produce, it is traditionally recognized as the most consistent measure of voice quality available.

Most of the subsequent voice quality measurement tools have involved algorithms and tools that can objectively measure voice quality. These are based on mathematical calculations on sound samples, rather than listening tests. In general, such tests can be roughly classified as active (or intrusive) and passive (or non-intrusive). Active tests perform calculations on test or simulated calls and thus intrude on normal network usage, while passive tests can perform calculations on active calls in live networks without any interruption of service.

It is costly to test the quality of voice networks at the component and system level and to measure the performance of active networks, since revenue-producing traffic must be interrupted to perform the tests. Further, while testing algorithms can quantify deficiencies in speech quality, they do not produce information to help localize and identify the root causes of the situations causing the deficiency. Passive tests run in live networks without interrupting active calls and use statistics gathered on active calls. The testing modules are actually embedded into the VoIP equipment at the use site and in the VoIP service provider's network. An example of such a system is provided by FIG. 2.

The PIQUA™ system of Texas Instruments Incorporated (Dallas, Tex.) is a collection of statistics, diagnostics, and the actions taken to identify anomalous operations and respond in real time whenever possible. Relevant statistics can be drawn from the VoIP endpoints in the network. These endpoints include user devices such as IP phones and video phones, IP set-top boxes, residential gateways, and media gateways. These endpoints use digital signal processors (DSPs) to execute software which encodes voice and performs the signal processing required to facilitate the transmission of voice between the various networks. This places the DSP in a strategic location for an objective measure of the user's experience. The DSP can identify and potentially compensate in some way for degraded voice quality. These responses may be classified as targeted parameter changes, changes in the voice coder-decoder (codec) in use, activation of diagnostic tools, and correlation of statistics that can signal an upper level network manager to either take action or inform the operator that problems exist in the network.

In current VOP deployments, voice quality issues are first typically discovered and reported by customers, which triggers an investigation and debugging by service providers. This method of problem detection can lead to longer problem resolution times and increase customer dissatisfaction. Currently, there exists no system or method that provides an enhanced means for service providers to effectively monitor their networks for potential voice quality issues and proactively isolate problems before customer complaints are received. Voice over Internet Protocol (VoIP) phone calls may be impaired due to various transient conditions in both the Customer Premise Equipment (CPE) devices and in the IP network. It is very difficult to root-cause the impairments after the call has ended and insufficient data on the affected call have been collected.

The reference network diagram of FIG. 3 depicts major entities and connections involved in a typical Voice over Internet Protocol (VoIP) telephony call. At subscriber premises, one or more phone terminals are connected through regular telephony wiring to Foreign EXchange Subscriber (FXS) ports 315 on the VoIP gateway 320. In addition, one or more Personal Computers (PC) 350 may be connected to the gateway 320 through a Local Area Network (LAN), such as Ethernet. The gateway is connected through a Wide Area Network (WAN) interface 325 to a broadband modem or other access device 330 that in turn establishes a Broadband Access Connection (BAC) 335 to the Internet Service Provider (ISP) and the Network Service Provider's (NSP) facilities 340. Gateway 320 may be combined with the modem 330 into one IAD unit. An example is the IAD 16 depicted in FIG. 1. For simplicity, the diagram assumes that the NSP and the Internet Service Provider (ISP) are the same entity. The Internet Telephony Service Provider (ITSP) 360 connects through the Internet 345 to both the ISP/NSP facilities 340 and the Remote End facilities 370. The latter facilities may be identical to the subscriber endpoint facilities described above, or may include a gateway to the Public Switched Telephone Network (PSTN) 380. The PSTN gateway may or may not be under control of the ITSP. The ISP/NSP 340 and ITSP 360 may also be implemented as the same entity.

As can be deduced from FIG. 4, VoIP communication may be impaired by problems with:
Local telephony—FXS port mis-operation, faulty phone wiring, faulty or low-quality phone terminals.
Local data network—basic connectivity, security breaches, collision of various traffic types, overload conditions.
Service provider network—packet loss, latency, jitter, reordering, and duplication, call server and gateway failures.

As a result of these technical problems, from a subscriber's perspective a call frequently cannot be established, or is of poor quality (e.g. distorted or one-way audio, and/or echo), or gets unexpectedly disrupted. Subscribers are accustomed to high-quality, always-on POTS. While subscribers may temporally tolerate problems with VoIP due to lower cost of such service, with falling POTS and mobile service prices, expectations for higher quality continually rise. Upon experiencing repeated call problems as described above, subscribers are likely to contact Customer Support of the ITSP and demand resolution.

Customer Support may attempt to troubleshoot the problem by collecting data from the subscriber's VoIP gateway and possibly execute special remote diagnostic tests. However, some of the problems described above may be of intermittent nature and thus not easily identified or fixed. For example, on some calls the problem may lie with the remote end and not the local end. Similarly, there may be transient conditions in the ISP/NSP network facilities or in ITSP's facilities that cause call quality impairments. The data on these problems can only be collected in real-time during an affected call. Without such data, Customer Service will only be able to send the subscriber a replacement VoIP gateway as an attempted remedy. If the original unit was not the source of the problem, the subscriber will continue to experience low call quality.

Sometimes it may be necessary for the ITSP's to “roll a truck” as an attempt to have a technician identify and resolve the problem on subscriber's premises. This is expensive to the ITSP and does not guarantee resolution of reported problems, especially if they are caused by non-local factors. Finally, if problems continue to be unresolved, the subscriber will likely switch to another ITSP (according to a recent market report, call quality is the dominant factor in subscribers' seeking of alternative ITSPs). This typically entails a large financial loss to the original ITSP due to significant up-front costs of subscriber acquisition.

There is a need for a real time collection of data to troubleshoot a VoIP system.

### SUMMARY

In light of the foregoing background, embodiments of the invention provide a method and apparatus to allow a subscriber to enter a pre-specified digit sequence using the phone terminal's keypad to induce a special data collection mode for the impaired call. The digit sequence is handled in a special manner to avoid inadvertent selection of options in an Interactive Voice Response (IVR) system into which the subscriber may be dialed, or inadvertent triggering of network-based supplementary call services.

Therefore, the system and method of embodiments of the invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrative of call placed over a voice-data network;

FIG. 2 illustrative of endpoints in communication system including Voice over Internet Protocol (VoIP) components;

FIG. 3 is a block diagram is a block diagram illustrative of Voice over Internet Protocol (VoIP) network connections;

FIG. 4 is a block diagram illustrative of ITSP connection to Voice over Internet Protocol (VoIP) call endpoints; and

FIG. 5 is a flowchart illustrative of method in accordance with an embodiment of the invention.

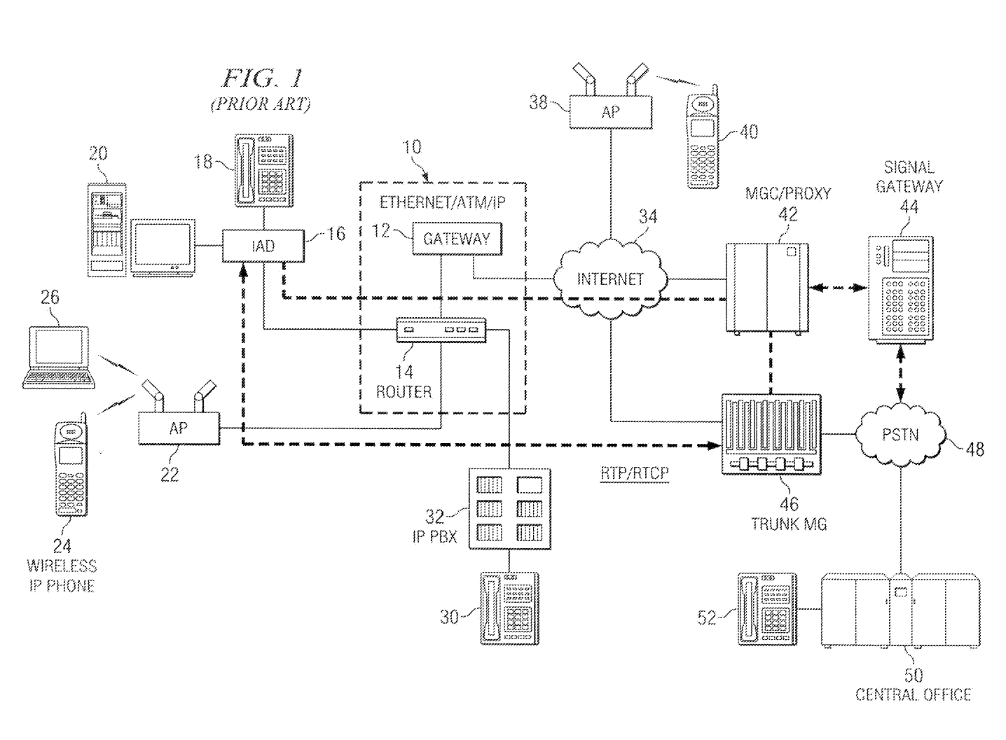

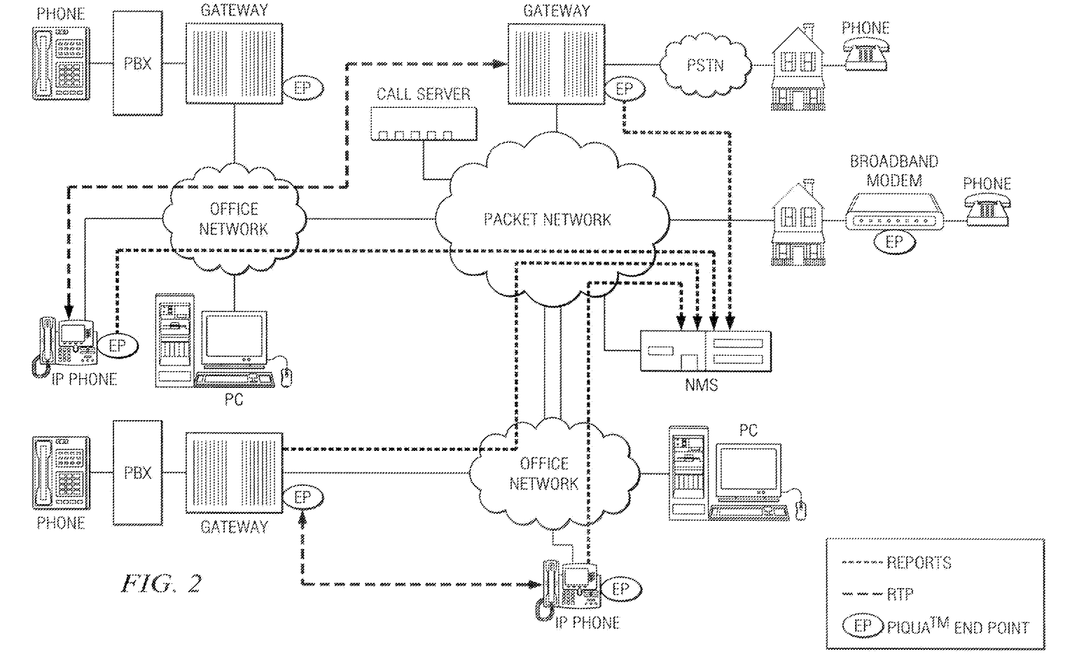

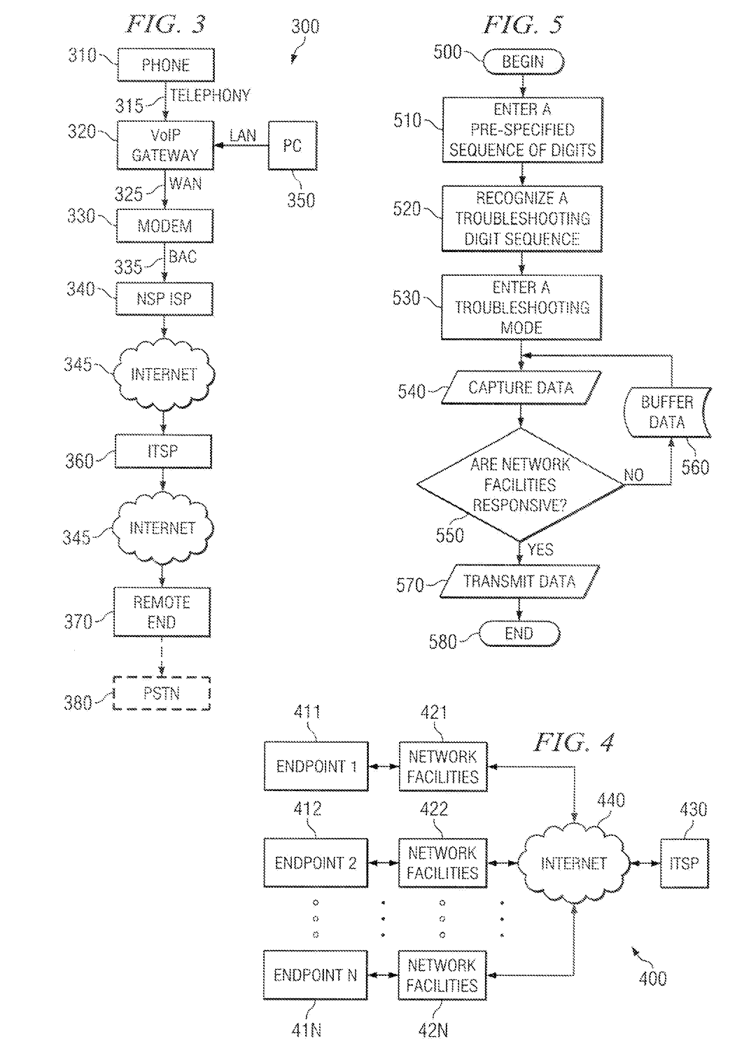

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

Referring now to FIG. 4, which is illustrative of ITSP connection to Voice over Internet Protocol (VoIP) call endpoints 400. The option of transmitting call data to ITSP facilities 430 in real time enables correlation of problems across the entire VoIP call connection. In a typical VoIP call arrangement, both the call signaling and media streams are processed and relayed by the ITSP network nodes. Thus, the ITSP may remotely induce the troubleshooting mode at the other endpoint of the call 412, 413, . . . , 41N, collect the resulting data, and correlate these data with data obtained from the first endpoint 411. 41N depicts a multi-party conference an implementation. In addition, if the ITSP has visibility into the intervening network nodes 421, 422, . . . , 42N, through which the call passes (e.g. when the ITSP owns a dedicated VoIP network or is an ISP/NSP), the ITSP may obtain additional state information to be correlated with the data sets from call endpoints. It is essential that the ITSP do so in real time, since the state of the network during the call is transient in nature and may be impossible to observe later.

Nodes on an IP network may include end-point VoIP network clients such as residential media gateways (RMG's), access devices such as Internet Protocol Phones (IPPs), wireless IPPs or their components such as DSPs, voice channels, codecs running on the DSPs, and individual algorithms used by a codec. In each channel, different modules of software may run voice-related algorithms that may include echo cancellation, packet loss concealment, and voice codecs.

Embodiments of the invention give the subscriber an ability to induce capturing of data on the VoIP call problems as they occur. Thus, the ITSP has a better chance of resolving the problems and retaining the subscriber as a satisfied customer.

Embodiments of the invention leverage subscriber's knowledge of the presence of real-time call quality impairments. A method in accordance with an embodiment of the invention is illustrated in FIG. 5. Beginning at 500, during a low-quality call, or right after noticing that a call may have been dropped by the other party, the subscriber enters a pre-specified sequence of digits using the phone's keypad 510. The word phone should not be deemed limited and can encompass any access device allowing access to the network. The pre-specified sequence of digits may be programmed in the VoIP gateway either at the time of its manufacture, or by the ITSP upon gateway deployment, and may be modified from time to time after the initial deployment.

This sequence has to be easily memorizable, short and unique, such that it is unlikely to cause inadvertent selection of options in an Interactive Voice Response (IVR) system the subscriber may be dialed into, or inadvertent triggering of network-based supplementary call services. Likewise, the sequence should not inadvertently trigger a supplementary call service that the ITSP may support.

Examples of this “dial to troubleshoot VoIP” sequence include:
“#*#”—usually the pound sign “#” is used to terminate a digit sequence entry in an IVR
“###”
“##*”

As an added protection against inadvertent selection of options in the IVR or triggering of supplementary services, the VoIP gateway may buffer the sequence digits and not transmit them unless the entire sequence is not completed within a pre-configured timeout. For example, in the case of a three-digit sequence, if the subscriber quickly enters only one or two first digits of the sequence and then pauses, upon reaching a several second timeout, the VoIP gateway may proceed with transmission of these digits to the network. Otherwise, the gateway would wait for the final digit and transmit the entire three-digit sequence only if it is not a troubleshooting sequence, thus preventing inadvertent action in the IVR or triggering of supplementary call services.

After the VoIP gateway recognizes the troubleshooting digit sequence 520, the VoIP gateway enters a call troubleshooting mode 530, which may also be signaled to the ITSP facilities either in the voice band, out-of-band (i.e., through extensions in the signaling channel), or both. The gateway may optionally locally signal entering this mode by emitting a tone or a pre-recorded verbal notification to the subscriber's phone. In addition, the gateway may indicate that this mode is entered by using visual notification on its front panel, e.g. by turning on or blinking a light signal, or by displaying a special message. The troubleshooting mode remains active until the subscriber hangs up the phone and all troubleshooting data have been collected and/or transmitted, as described below.

In general, the VoIP gateway may take several actions in troubleshooting mode:

Collect Data 540

This is the simplest response that entails recording and local storage of the current call characteristics in the VoIP gateway. These data, possibly accumulated from multiple problems calls in the buffer 560, can later be retrieved by the ITSP personnel, either remotely or on-site, to troubleshoot the problem. The data may also be automatically sent by the gateway to ITSP facilities some time after the troubleshooting mode ends, e.g. during low call activity at nighttime 570.

Transmit Data to ITSP in Real Time.

This entails the collection of call data and simultaneous transmission of these data to ITSP facilities for subsequent analysis. If the ITSP facilities are unresponsive due to peak usage conditions, the data is buffered 560 on the gateway and sent later 570, as described above. The method ends 580.

Conduct Interactive Troubleshooting.

This entails the VoIP gateway prompting the subscriber, by means of pre-recorded verbal messages, to take certain troubleshooting actions. Alternatively, this mode may entail real-time interaction with ITSP's Customer Support personnel if such is available at that time. While this mode is the most effective, it is also the most disruptive to the current call and may not be desirable by the subscriber or the remote party, especially if call impairments are not critical in nature. This mode may be triggered by the subscriber entering an alternative digit sequence.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A method for troubleshooting a telecommunication network, said method comprising:
entering a pre-specified sequence of digits using a keypad on an access device;
recognizing the pre-specified sequence of digits as a troubleshooting digit sequence;
entering a call troubleshooting mode and optionally signaling this mode to the network or to the local subscriber, or both;
capturing a plurality of call characteristics; and
ending the call troubleshooting mode when the subscriber hangs up the phone and all troubleshooting data have been collected.

2. The method according to claim 1, further comprising:
buffering the pre-specified sequence of digits; and
transmitting the buffered sequence of digits if the pre-specified sequence of digits is not completed within a pre-configured timeout.

3. The method according to claim 1 or 2, wherein the plurality of call characteristics is transmitted to network facilities simultaneous with capturing.

4. The method according to claim 1 or 2, further comprising:
buffering the plurality of call characteristics; and
transmit the plurality of call characteristics during a low activity period.

5. The method according to claim 1 or 2, further comprising:
indicating entering the call troubleshooting mode by emitting a tone.

6. The method according to claim 1 or 2, further comprising:
indicating entering the call troubleshooting mode by playing a pre-recorded verbal notification to the subscriber's phone.

7. The method according to claim 1 or 2, further comprising:
indicating entering the call troubleshooting mode by playing by using visual notification.

8. The method according to claim 1 or 2, further comprising:
prompting the subscriber to take certain troubleshooting actions.

9. The method according to claim 1 or 2, further comprising:
notifying the network about entering the call troubleshooting mode.

10. The method according to claim 2, wherein a plurality of data from multiple calls are captured.

11. A method for troubleshooting a telecommunication network, said method comprising:
entering a pre-specified sequence of digits using a keypad on an access device;
recognizing the pre-specified sequence of digits as a troubleshooting digit sequence for a real-time interactive mode; and
entering a real-time interactive mode with support personnel.

12. The method according to claim 10, further comprising:
buffering the pre-specified sequence of digits; and
transmitting the buffered sequence of digits if the pre-specified sequence of digits is not completed within a pre-configured timeout.
